(19) United States
(12) Patent Application Publication
(10) Pub. No.: US 2021/0136023 A1
(43) Pub. Date: May 6, 2021

(54) SOCIAL NETWORK BASED LEARNING AND CREATION SYSTEM AND COMPUTER PROGRAM PRODUCT

(71) Applicant: National Central University, Taoyuan City (TW)

(72) Inventors: Li-Chieh CHANG, Taoyuan City (TW); Yen-An SHIH, Taoyuan City (TW); Fang-Chen LU, Taoyuan City (TW)

(73) Assignee: National Central University, Taoyuan City (TW)

(21) Appl. No.: 16/687,828

(22) Filed: Nov. 19, 2019

(30) Foreign Application Priority Data
Oct. 30, 2019 (TW) 108139231

(51) Int. Cl. H04L 12/58; G06Q 50/00; G06Q 50/20; G06F 3/0484

(52) U.S. Cl. CPC H04L 51/32; G06Q 50/01; G06F 3/0484; H04L 51/04; G06Q 50/20

(57) ABSTRACT

The present invention relates to a learning and creation system based on social network, comprising: a central server installed with a social network based learning creation computer program product comprising a concept map collaborative module and an instant messaging module; and a plurality of user devices, each of which the plurality of user devices executes an internet browser, in communication with the central server through an internet, and accesses the social network based learning creation computer program product through the internet browser and provides the concept map collaborative module and the instant messaging module for a user to operate in response to an operation from the user, wherein the concept map collaborative module is configured to provide a plurality of graphical objects based on a graphical concept map for a plurality of the users to perform a co-construction for the same concept and provide for the plurality of the users to engage an instant messaging by enabling the instant messaging module in the concept map collaborative module, through the internet browser.

### CROSS-REFERENCE TO RELATED APPLICATION

The present application claims the priority benefit of Taiwan invention patent application serial No. 108139231, dated Oct. 30, 2019, filed in Taiwan intellectual property office. All contents disclosed in the above Taiwan invention patent application is incorporated herein by reference.

### FIELD

The present invention relates to a learning and creation system and computer program product based on a social network, in particular to a learning and creation system and computer program product based on a social network including a concept map collaborative module coupled with both an instant messaging module and a social network module.

### BACKGROUND

In current society where we people are living in, a variety of social networking applications (SNAs), such as: Facebook, Instagram, Line, WeChat, Academia.edu, ResearchGate, and etc., have already been integrated into everyone's daily life, and seem to be everywhere. In prior art, it is conventionally considered the principal function and value concerning these SNAs are to provide social networking based services, so as to share, circulate, and deliver messages among people and enhance social connections among we people.

Recently experts have commenced exploring and considering about the potential and possibility that SNAs provide for learning and open education (Lampe, Wohn, Vitak, Ellison, & Wash, 2011; Meishar-Tal & Pieterse, 2017). The conclusion is that most of these SNAs lack of essential and indispensable elements in teaching and learning process (pedagogy), and therefore causes a stereotype that these SNAs shall not be actually applied to the field of education (Mnkandla & Minnaar, 2017). In particular, most of these SNAs are usually focus on encouraging people to keep tracking of what are their friends doing or what do they care about, and on the contrary rarely encourage people to keep developing and building a sense of concept or idea which is considered much positive and constructive (Lewis, Pea, & Rosen, 2010). These SNAs in the state of the art, is just to provide an online virtual space for users and fails to render users gaining knowledge and keep users up therefrom.

However, by reference with other resembling concepts regarding internet based technology, such as, Web 20, knowledge building, computer-supportive collaborative learning, and etc., what these resembling concepts initiate are as follows. For all of users on the respective nodes included in the internet, every individual user is able to intensively collaborate with any of other users according to one's own free will. As long as one has a strong will and motivation and decides to contribute, any individual user is able to serve as an aggressive contributor (O'Reilly, 2005; Scardamalia & Bereiter, 2014; Wasson, Ludvigsen, & Hoppe, 2013)

In particular, users with similar interests can jointly create their own knowledge and expertise and learn together, rather than discover knowledge. Users' work is primarily valued for what it contributes to the group. For such framework provided by these resembling concepts regarding internet based technology, every user involved in is both a knowledge provider and a knowledge acceptor in the meantime. While providing and outputting knowledge, one is absorbing, learning and inputting knowledge as well in the meantime, in which the basic spirit of education has already implied.

For example, if it is able to arrange few well-designed and particularly arranged learning activities, which is dominated and leaded by an expert, for providing a fully open and totally free exchanging fundamental architecture for users to jointly accomplish an exchange and construction for the same concept during the activity. More specifically, these SNAs are used to link up and integrate every contribution from every individual user, and most importantly, guide users away from a conventional mode of “participation” and transforming to a novel mode of “co-construction”.

Hence, there is a need to solve the above deficiencies/issues.

### SUMMARY

In view of fact that social networking service do have many powerful positive advantages, such as, facilitating a discussion and exchanging among people, facilitating a circulation of knowledge, message sharing, crating group power, producing collective intelligence, producing crowd intelligence, producing idea innovation, producing addiction possibility, interesting, enhancing emotional linkage, and etc. Actually above these positive advantages possibly have potential to apply to fields, such as but not limited to, learning, education, creative innovation, concept construction, and creative design etc.

Hence, the present invention provides a learning and creation system based on social network, including: a central server installed with a social network based learning creation computer program product including a concept map collaborative module and an instant messaging module; and a plurality of user devices, each of which the plurality of user devices executes an internet browser, in communication with the central server through an internet, and accesses the social network based learning creation computer program product through the internet browser and provides the concept map collaborative module and the instant messaging module for a user to operate in response to an operation from the user, wherein the concept map collaborative module is configured to provide a plurality of graphical objects based on a graphical concept map for a plurality of the users to perform a co-construction for the same concept and provide for the plurality of the users to engage an instant messaging by enabling the instant messaging module in the concept map collaborative module, through the internet browser.

Preferably, the learning and creation system further includes a conductor device executing an internet browser, in communication with the central server through an internet, and accessing the social network based learning creation computer program product through the internet browser and providing the concept map collaborative module and the instant messaging module for a conductor to operate in response to an operation from the conductor.

Preferably, the social network based learning creation computer program product further includes: a social network module configured to provide for the plurality of the users and the conductor to build a social network through the internet browser executed on the plurality of user devices and the conductor device; a co-construction process as the note module configured to provide for the plurality of the users and the conductor to automatically organize all of co-construction processes performed by the plurality of the users and the conductor as a note automatically through the internet browser executed on the plurality of user devices and the conductor device; an assignment management module configured to provide for the plurality of the users to manage an assignment and to submit the assignment to the conductor through the internet browser executed on the plurality of user devices and the conductor device; a friend request module configured to provide for the plurality of the users and the conductor to newly add a friend through the internet browser executed on the plurality of user devices and the conductor device; the concept map collaborative module configured to provide the plurality of graphical objects based on the graphical concept map for the plurality of the users and the conductor to perform the co-construction for the same concept and provide for the plurality of the users and the conductor to engage an instant messaging by enabling the instant messaging module in the concept map collaborative module, through the internet browser executed on the plurality of user devices and the conductor device; and the instant messaging module configured to provide for the plurality of the users and the conductor to engage an instant messaging and to enable the concept map collaborative module in response to an operation from the plurality of the users or the conductor, through the internet browser executed on the plurality of user devices and the conductor device.

Preferably, the co-construction includes one of activates of a co-creation, a co-innovation, a mutual discussion, a brain storming, a collaborative working, a partnership working, and a combination thereof.

The present invention further provides a computer program product, embodied on a non-transitory computer-readable storage medium and loaded and executed by a computerized system including a central server and a plurality of user devices being communicatively linked with each other through an internet, for learning and creation based on social network, including: a computer code of a concept map collaborative module configured to provide for a plurality of users to operate through an internet browser executed on the plurality of user devices, provide a plurality of graphical objects based on the graphical concept map for the plurality of the users to perform a co-construction for the same concept through the internet browser in response to operations from the plurality of users, and provide for the plurality of the users to engage an instant messaging by enabling an instant messaging module in the concept map collaborative module; and a computer code of an instant messaging module configured to provide for the plurality of users to operate through the internet browser executed on the plurality of user devices, and provide for the plurality of the users to engage the instant messaging or enable the concept map collaborative module through the internet browser in response to operations form the plurality of users.

Preferably, the computer program product further includes: a computer code of a social network module configured to provide for the plurality of users to operate through the internet browser executed on a plurality of user devices, and provide for the plurality of users to build a social network through the internet browser executed on the plurality of user devices in response to operations form the plurality of users; a computer code of a co-construction process as the note module configured to provide for the plurality of users to operate through the internet browser executed on the plurality of user devices, and provide for the plurality of users to organize all of co-construction processes performed by the plurality of the users as a note automatically through the internet browser executed on the plurality of user devices in response to operations form the plurality of users; a computer code of an assignment management module configured to provide for the plurality of users to operate through the internet browser executed on the plurality of user devices, and provide for the plurality of the users to manage an assignment and to submit the assignment to a conductor through the internet browser executed on the plurality of user devices in response to operations form the plurality of users; and a computer code of a friend request module configured to provide for the plurality of users to operate through the internet browser executed on the plurality of user devices, and provide for the plurality of the users to newly add a friend through the internet browser executed on the plurality of user devices in response to operations form the plurality of users.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 shows a system architecture diagram of the social learning and creation system in accordance with the present invention;

FIG. 2 shows a user interface diagram of a social network module included in the social learning and creation program platform in accordance with the present invention;

FIG. 3 shows a user interface diagram of a concept map collaboration module included in the social learning and creation program platform in accordance with the present invention;

FIG. 4 shows a user interface diagram of an instant messaging module included in the social learning and creation program platform in accordance with the present invention;

FIG. 5 shows a user interface diagram of a new contact module included in the social learning and creation program platform in accordance with the present invention;

FIG. 6 shows a user interface diagram of a co-construction process as the note module included in the social learning and creation program platform in accordance with the present invention;

FIG. 7 shows a schematic diagram of the social learning and creation program platform in accordance with the present invention executed on a desktop computer through a browser;

FIG. 8 shows a schematic diagram of the social learning and creation program platform in accordance with the present invention executed on a tablet device through a browser; and

FIG. 9 shows a schematic diagram of the social learning and creation program platform in accordance with the present invention executed on a smart phone through a browser.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “including”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

With the vigorous development of social networking service (SNS), everyone can easily share their ideas on the social network. Undoubtedly, this trend has indeed affected traditional learning and education process. However, the traditional view is that SNS can only bring negative effects on learning and education. The common question is that students may be addicted to SNS and ruin their studies. But in fact, SNS also has many powerful and positive advantages, such as but not limited to: promoting discussion and communication, promoting knowledge circulation, message sharing, group motivation, collective wisdom, idea inspiration, addiction possibility, fun, and enhancing emotional connection, etc. These advantages especially have capacities for applying to the fields of learning, education, creative thinking, concept construction, and creative design, etc. Therefore, if one can deliberate to take advantage of it and eliminate their disadvantages while adding some other elements, it is possible to create a new type of learning and creation system and platform.

The present invention proposes and builds a social learning and creation system and a corresponding program platform, which apply cloud computing technologies of software as a service (SaaS) and platform as a service (PaaS) to construct a cloud-like service platform and provide users with access, operation and use through Internet as well as Internet browser as a digital assistant tool for learning, education, creative thinking, concept construction, and creative design. Users only need to access Internet in a networkable environment through the browser running on the users' device to be able to access, operate and use the system and the platform. The social learning and creation system in accordance with the present invention can be provided to the user in an off-premises manner, and the user can access and use the system and platform only by subscribing to Internet for permission.

The social learning and creation program platform in accordance with the present invention includes hardware at the physical device layer and program platform (computer program product) at the application layer. According to the definition of International Open System Interconnection Reference Model (OSI/RM) architecture, the social learning and creation program platform in accordance with the present invention and its multiple constituent modules are the software application services running on the 7th layer (application layer) of the OSI/RM architecture. The software application service at the 7th layer can independently select various communication protocols at the 4th transmission layer, and form data packets at the 3rd network layer and determine the transmission path, which, after passing through the 2nd data link layer and together with logical link control (LLC) and media access control (MAC), establishes the required two-way communication link (upload communication link, download communication link) with various devices located at the 1st physical layer, such as but not limited to: server, device, user device, and other components.

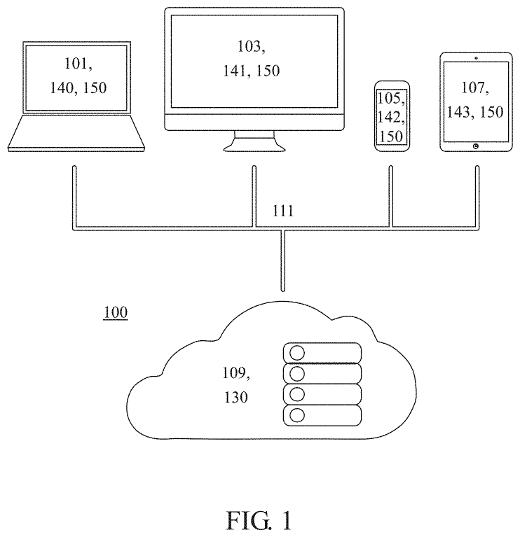

FIG. 1 shows a system architecture diagram of the social learning and creation system in accordance with the present invention. The social learning and creation system 100 shown in FIG. 1 is composed of a number of hardware and program platforms. A plurality of devices at the physical device layer includes, for example but not limited to: a plurality of local-end user devices including a notebook computer 101, a desktop computer 103, a smart phone 105 and a tablet device 107, and a remote-end server device including a central server 109. The local-end devices of the notebook computer 101, desktop computer 103, smart phone 105 and tablet device 107 are linked to central server 109 through Internet 111 for communicating and accessing data with central server 109 in two ways. Internet 111 is formed by mixing the local area network (LAN), wide area network (WAN), GSM network, 4G network, 5G network, 6G network, Wi-Fi network, Bluetooth network and their combinations.

The social learning and creation program platform 130 in accordance with the present invention at the application layer is composed of a plurality of characteristic modules including but not limited to: a social network module, an instant messaging module, a concept map collaborative module, a co-construction process as the note module, a new contact module, and an operation management module, which are installed and stored in the central server 109 and executed in the central server 109. The central server 109 is preferably an application server for storing and executing the social learning and creation program platform in accordance with the present invention, and providing services to users through the Internet 111 using SaaS technology and PaaS technology, wherein the instant messaging module and the concept map collaboration module are configured to have an interconnection relationship. The concept map collaboration module can be directly activated from the instant messaging module, and the instant messaging module can be directly used in the concept map collaboration module, namely, there is a certain degree of coupled relationship between them.

A user only needs to use a user device such as a notebook computer 101, a desktop computer 103, a smart phone 105 or a tablet device 107, and establish a communication link with the central server 109 via the Internet 111, such that the user can use an Internet browser 140-143 executing on the user device to directly access, operate and use the social learning and creation program platform 130 on the central server 109. Alternatively, the user can also download via the Internet 111, install a social learning and creation program platform application 150 on the notebook computer 101, desktop computer 103, smart phone 105 or tablet device 107, and use the social learning and creation program platform application 150 to access, operate and use the social learning and creation program platform 130 on the central server 109.

Based on the SNS, the invention captures the features of SNS, for example but not limited to: promoting knowledge circulation, promoting discussion and communication among users message, sharing, group motivation, collective wisdom, idea inspiration, fun, and enhancing emotional connection, etc., and further combines tools such as instant messaging (IM) and concept map to form a composite multi-functional system and platform, which is especially suitable for application to digital assistance tools such as but not limited to: learning, education, creative thinking, concept construction, and creative design, etc. SNS provides a variety of ways for users to communicate, generally including chatting, mailing, photos, audio and video, file sharing, blogs, news groups, etc. The social learning and creation program platform in accordance with the present invention uses the community network module to provide users with audio and video, file sharing, blogs, news groups and other functions, and through the instant messaging module to provide users with online chat function.

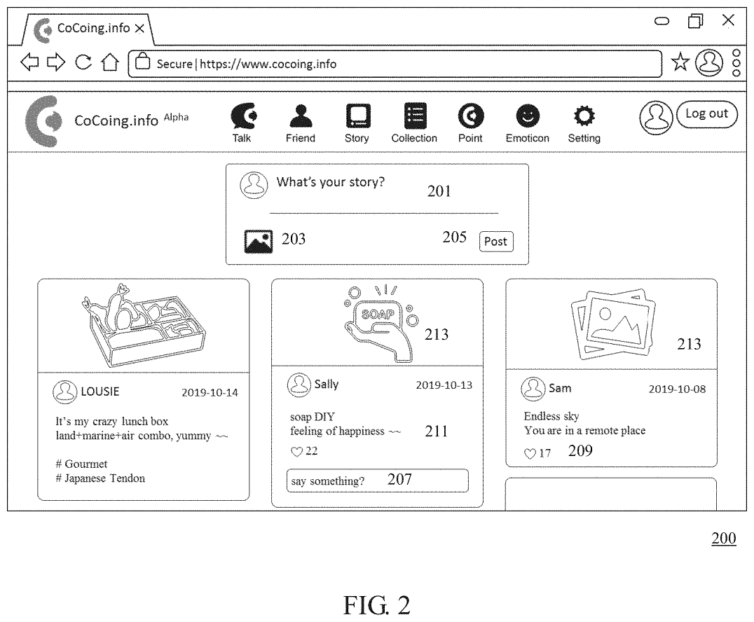

FIG. 2 shows a user interface diagram of a social network module included in the social learning and creation program platform in accordance with the present invention. The social network module included in the social learning and creation program platform provides a social networking service (SNS) including audio and video, file sharing, blogs, news groups and the like for users to operate through a social network interface 200, as shown in FIG. 2. Preferably, the social network interface 200 is visually presented in a responsive web design and a graphic layout, including but not limited to a publishing field 201, a file upload field 203, a publishing key 205, a message field 207, a love key 209, a timestamp field 211, and a plurality of irregularly arranged frames 213 etc.

The user can open a discussion string in the message field 201 by free speech in words, and upload and share corresponding photos, audio and video, and files through the file upload field 203, and after completion press the publishing key 205 to publish the speech and file on the platform. A person's speech and file, and time of publication will be fully presented in the frames 213 and the timestamp field 211, respectively. After other users see it, if they like, they can press the love key 209 to encourage him, or use the message field 207 to conduct dialogue and discussion. Through the social network module provided by the present invention, each user can start from a single point and establish a person connection with many other users. If there are many users involved, each user can be regarded as a node, and the person connection between the users can be regarded as a line. The people social network formed, after graphical representation, is presented as a topological form of radial network.

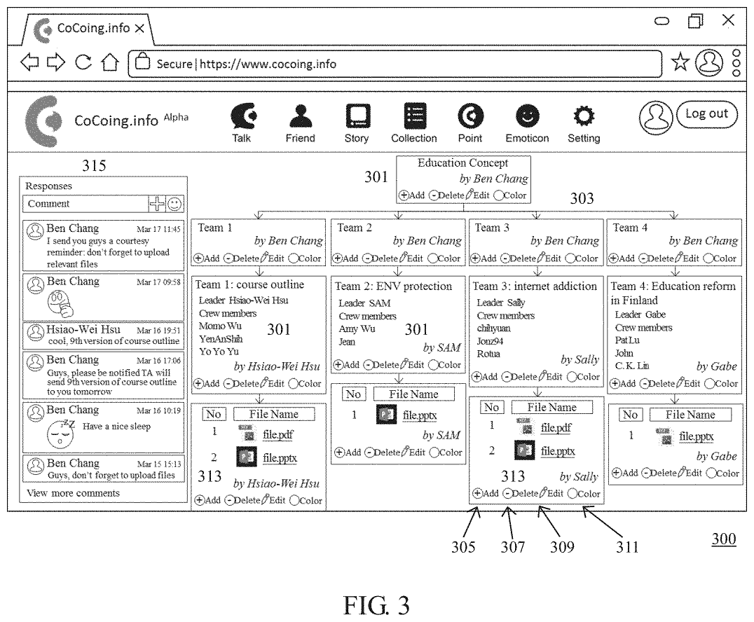

FIG. 3 shows a user interface diagram of a concept map collaboration module included in the social learning and creation program platform in accordance with the present invention. In the basic definition of concept map, a graphical figure is composed of a plurality of graphic objects each representing a different meaning, and the relationship between the concepts is specifically presented and indicated by diagrams. In a concept map, concepts are represented by square or circular graphic objects, such as but not limited to: “earth environment”, “human”, “plant” and “animal” and the like preferably described by referring to nouns. The relationship between the concepts is linked by graphic objects with arrow segments containing conjunctions, such as but not limited to: “trigger”, “cause”, “need”, “provide” and the like preferably described by referring to verbs. The direction of the arrow represents the level of downward development, and by combining these graphic objects a concept map is drawn. The concept map is used as a means of expression, and multiple abstract concepts and the relationship between them are visualized.

It is generally believed that concept map can systematically deconstruct and organize complex knowledge through systematization and systematic logic, and the construction process of concept map itself is a very meaningful process of learning and knowledge absorption. But in fact, the figure of the concept map itself also shows a topological form of radial network, and seems to have some commonality with the social network. Therefore, the present invention further combines the concept maps on the basis of SNS in order to connect universal concepts and people by combining SNS and concept maps.

The core module of the program platform in accordance with the present invention is a concept map collaborative module, which is open for operation to guides such as but not limited to a teacher, a mentor, an expert or an educator, as well as open to users such as but not limited to a student, a participant, or a subscriber. In the present invention, unless otherwise specified, the user refers to all users including the guide. The concept map collaboration module provides a plurality of graphical basic graphic objects through a concept map collaboration interface 300 as shown in FIG. 3, such as a plurality of square objects 301 and a plurality of arrow objects 303 for the guide and user to operate in order to carry out joint discussion or group cooperation between the concepts on the same topic.

The guide preferably sets a big generic and abstract concept such as but not limited to educational issues. Then, starting from the big concept, users are allowed to freely discuss under the same big concept, and further expand the big concept into multiple specific concepts, such as but not limited to: curriculum issues, environmental education issues, Internet addiction and security issues, as well as Finland's education reform and other specific concepts. As the discussion progresses, more levels of sub-concepts can be further developed. Big concepts and specific concepts are represented by the square object 301, and the relationship between the big concept and the specific concept is linked through the arrow object 303, finally forming a concept map, so that the original vague and abstract big concepts will finally form a clear and hierarchical knowledge base through the process of joint discussion and concept co-construction.

The concept map collaboration interface 300 in accordance with the present invention, in addition to providing basic graphic objects required for constructing the concept map, also provides a plurality of functional components, such as but not limited to: a concept addition key 305, a concept deletion key 307, a concept editing key 309, a concept coloring key 311, and a file upload window 313. The guide and user can construct a concept map according to their own ideas and provide the required files, including but not limited to: video, audio, image, or file etc. by operating the concept addition key 305, concept deletion key 307, concept editing key 309, concept coloring key 311, and file upload window 313.

In the concept map collaboration interface 300 in accordance with the present invention, an instant messaging function window 315 is also included to further integrate the functions of instant messaging module, so that in the process of jointly constructing a concept map, the guide and user can immediately and fully discuss and jointly construct concept, making the concept and related knowledge quickly circulated. Each user can develop and construct their own social network through the concept map collaboration module, develop and construct their own concepts, share them with peers, or co-construct concepts with peers, and circulate these concepts through the established social network. Users can also organize their own friends into the social network. The concept map collaboration module proposed by the invention is not only suitable for application in the fields of learning, education and the like, but also in the fields of innovative creation such as creative thinking, concept construction, and creative design and the like.

The social learning and creation system in accordance with the present invention can also be described as a composite digital whiteboard built on cloud service architecture and designed to mix with IM and SNS functions to allow the users, under the guidance and supervision of the guide, to freely carry out concept construction for the same concept. The process that users operate and use the concept map collaboration module is to implement and realize, for example but not limited to collaborative and co-construction process as the learning, user driven, knowledge construction, knowledge network and other educational concepts.

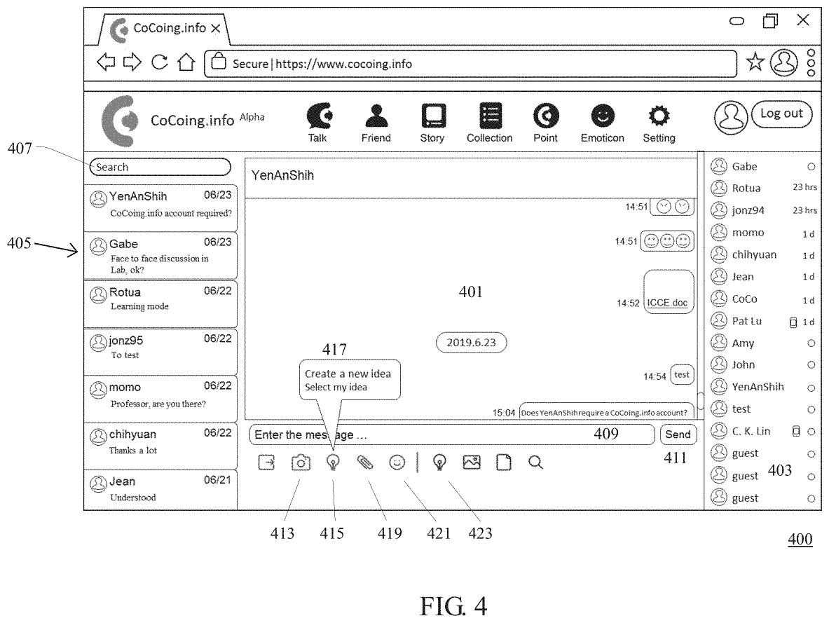

FIG. 4 shows a user interface diagram of an instant messaging module included in the social learning and creation program platform in accordance with the present invention. The instant messaging included in the SNS such as but not limited to Line messenger has the interface widely recognized as easy-to-use. However, if it is to be directly applied to learning, education, creative thinking, concept construction, creative design and other purposes, there is still a lot of lack of functions to be supplemented. Nevertheless, it has dominant advantages of easy to use and convenience for users. Therefore, the instant messaging module included in the social learning and creation program platform in accordance with the present invention provides instant communication to the user via an instant messaging interface 400 as shown in FIG. 4, which mainly includes but is not limited to: a group instant messaging window 401, a group name list window 403, a speech search window 405, a speech search field 407, a speech field 409, a speech sending-out key 411, a camera turning-on live broadcast key 413, a concept initiation key 415, a concept selection window 417, a file upload key 419, an emoticon key 421, and a photo upload key 423.

A user can type in what he wants to say in the speech field 409, and then press the speech sending-out key 411. What he said will be displayed in the group instant messaging window 401. Users can also see what others say in the group instant messaging window 401. The instant messaging module in accordance with the present invention uses a message queue as a communication protocol for asynchronous conferencing to process the inter-process communication or the inter-thread communication of the same process. Detailed records in each queue include but not limited to: time of occurrence, type of input device, and specific input parameters, etc., which is suitable for performing asynchronous but instantaneous statistical multiplexing communication with a certain delay. All users' speeches in the group instant messaging window 401 will be arranged in order according to their speaking time.

A user can also provide live pictures through the camera turning-on live broadcast key 413, provide corresponding files through the file upload key 419, add emoticons through the emoticon key 421, and provide corresponding photos through the photo upload key 423 to allow the process of chatting and discussion more interesting. All users participating in instant messaging will be displayed in the group name list window 403. The instant messaging module in accordance with the present invention also provides users to select a specific user to send private messages from the group name list window 403, or alternatively enable private instant messaging. Users can also search the speeches of the group instant messaging window 401 through the speech search field 407, and the retrieved speeches will be displayed in the speech search window 405.

The instant messaging interface 400 of the instant messaging module in accordance with the present invention further includes a concept initiation key 415. After a user presses the concept initiation key 415, a concept selection window 417 will pop up, providing two options for the user to choose. The first is to create a new concept, and the second is to select my idea. No matter which option the user chooses, it will be directly linked to the corresponding concept item in the concept map collaboration module, and initiates the concept map collaboration interface 300. The concept map collaboration module can be directly activated from the instant messaging module, and the instant messaging module can also be directly used in the concept map collaboration module. The above interconnection relationship exists between the two modules after configuration. When the user is using the instant messaging module for group chat and discussion and suddenly inspiration is inspired, the concept initiation key 415 can be immediately pressed to start a new concept map collaboration process to capture the flash inspiration. Therefore, the social learning and creation system in accordance with the present invention is not only suitable for application in the field of learning and education, but also suitable for application in creative thinking, concept construction, and creative design.

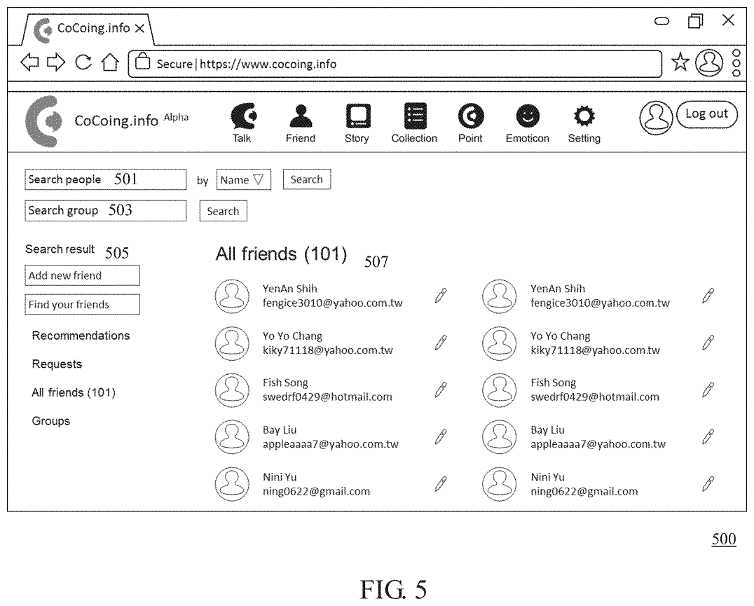

FIG. 5 shows a user interface diagram of a new contact module included in the social learning and creation program platform in accordance with the present invention. The new contact module included in the social learning and creation program platform provides a user to add new contact in the instant messaging module and the social network module through a new contact interface 500, as shown in FIG. 5. The new contact interface 500 mainly includes but is not limited to a name search field 501, a group search field 503, a search result window 505, and an existing contact list 507. Users can add contacts in the instant messaging module and the social network module by operating the above components.

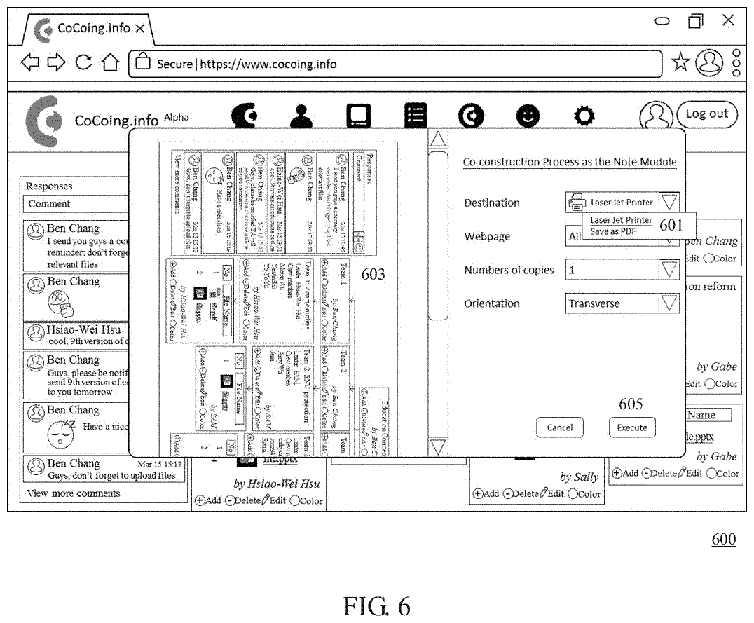

FIG. 6 shows a user interface diagram of a co-construction process as the note module included in the social learning and creation program platform in accordance with the present invention. As mentioned above, the process of constructing a concept map by a user, whether it is self-constructed or co-constructed with peers, is a very meaningful process of learning, knowledge absorption, and knowledge construction. If the process of implementing the collaborative and co-construction process as the learning, user driven, knowledge construction, and knowledge network can be completely recorded and preserved, it will produce the same effect as the course notes. Therefore, the social learning and creation program platform in accordance with the present invention further provides a co-construction process as the note module, which can automatically organize all the co-construction process of a certain idea in the concept map collaboration module through a co-construction process as the note interface 600, and provide options for printing notes into paper document or storing them as a PDF file for users to choose. The co-construction process as the note interface 600 also includes a note option window 601, a note preview window 603, and an execution key 605 and the like for users to choose.

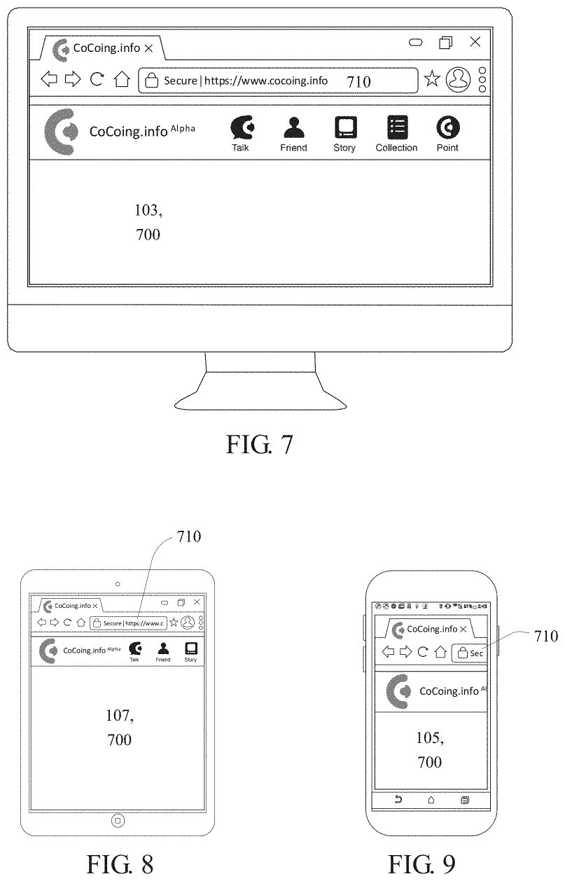

FIG. 7 shows a schematic diagram of the social learning and creation program platform in accordance with the present invention executed on a desktop computer through a browser. FIG. 8 shows a schematic diagram of the social learning and creation program platform in accordance with the present invention executed on a tablet device through a browser. FIG. 9 shows a schematic diagram of the social learning and creation program platform in accordance with the present invention executed on a smart phone through a browser. Since the social learning and creation system and the program platform in accordance with the present invention use SaaS technology and PaaS technology to directly provide services to users through the Internet and cloud service technologies, after login and registration, the same user can operate his own user devices at home, office, outdoors, or any place, only in a networkable environment, by inputting a set of uniform resource locator (URL) (also known as a domain name) of the social learning and creation program platform in accordance with the present invention into the website address column 710 of the browser 700 to directly link, access, operate, and use the social learning and creation program platform in accordance with the present invention anytime and anywhere. The user devices include but are not limited to a desktop computer 103 as disclosed in FIG. 7, a tablet device 107 as disclosed in FIG. 8, or a smart phone 105 as disclosed in FIG. 9. The social learning and creation program platform in accordance with the present invention can be applied anytime and anywhere and has a ubiquitous characteristic.

Actually, in the process of continuously accessing, using and operating the social learning and creation system and the program platform in accordance with the present invention by a user, the following functions can be achieved through the social learning and creation system and the program platform in accordance with the present invention: (a) practice of co-construction concept (or concept co-creation), (b) formation of social networks, (c) continuous circulation and dissemination of the created concepts across the social networks, (d) ubiquitous and accessible usability, and the realization and implementation of many core concepts, such as but not limited to: social learning network, social enhanced learning, co-construction concept building, concept dissemination across social networks, organization of social networks, cloud concept building and sharing platform, knowledge network construction, expert-guided social learning network, learning and creation-oriented platform, co-creation platform, education purpose platform, co-construction process as the learning, decentralized learning, open learning, learning management and other concepts.

The social learning and creation system and the program platform in accordance with the present invention can be preferably applied as a learning management system, which is an essential platform for teachers to give lessons and students to learn in the campus, and can also be applied as a digital assistance platform or tool in the field of creative thinking, concept construction and creative design.

The social learning and creation system and the program platform in accordance with the present invention can support learners to actively, individually and collaboratively build a specific concept, and help learners to spread their concepts in a social network environment. In terms of supporting learners to build a concept, the concept map collaboration module is an effective tool. In terms of disseminating the concept of learners, the seamless social network module is a very effective way because it can provide instant feedback for users anytime anywhere. Therefore, in the process of accessing, using and operating the social learning and creation system and the program platform in accordance with the present invention, users can obtain the effect of co-construction concept by the learners, and seamlessly and effectively interact and learn through the social network. Therefore, from the perspective of learning and education, the system and the platform in accordance with the present invention proposed with SNS combined with a concept map should effectively promote the social interaction and concept organization of learners, and the learning process will be full of inspiration and fun.

In the use and interaction of the social learning and creation system and the program platform in accordance with the present invention, after being used and tested in the alpha version and after data collection, analysis and statistics, about 31.24% pertains to the interaction of concept construction, and about 68.76% pertains to the user's reply. Further, the results of analysis of the key member social network show that the guide, i.e. the teacher, plays a vital role in initiating concept construction and triggering social interaction in the conceptual construction social network. The big data obtained after the implementation of the invention can be further used to, but not limited to, key member identification, individual interaction mode exploration, machine automatic scoring mechanism based on individual contribution to the social network, and generating high added value.

There are further embodiments provided as follows.

Embodiment 1: A learning and creation system based on social network, includes: a central server installed with a social network based learning creation computer program product including a concept map collaborative module and an instant messaging module; and a plurality of user devices, each of which the plurality of user devices executes an internet browser, in communication with the central server through an internet, and accesses the social network based learning creation computer program product through the internet browser and provides the concept map collaborative module and the instant messaging module for a user to operate in response to an operation from the user, wherein the concept map collaborative module is configured to provide a plurality of graphical objects based on a graphical concept map for a plurality of the users to perform a co-construction for the same concept and provide for the plurality of the users to engage an instant messaging by enabling the instant messaging module in the concept map collaborative module, through the internet browser.

Embodiment 2: The learning and creation system as described in Embodiment 1, further includes: a conductor device executing an internet browser, in communication with the central server through an internet, and accessing the social network based learning creation computer program product through the internet browser and providing the concept map collaborative module and the instant messaging module for a conductor to operate in response to an operation from the conductor.

Embodiment 3: The learning and creation system as described in Embodiment 2, the social network based learning creation computer program product further includes: a social network module configured to provide for the plurality of the users and the conductor to build a social network through the internet browser executed on the plurality of user devices and the conductor device; a co-construction process as the note module configured to provide for the plurality of the users and the conductor to automatically organize all of co-construction processes performed by the plurality of the users and the conductor as a note automatically through the internet browser executed on the plurality of user devices and the conductor device; an assignment management module configured to provide for the plurality of the users to manage an assignment and to submit the assignment to the conductor through the internet browser executed on the plurality of user devices and the conductor device; a friend request module configured to provide for the plurality of the users and the conductor to newly add a friend through the internet browser executed on the plurality of user devices and the conductor device; the concept map collaborative module configured to provide the plurality of graphical objects based on the graphical concept map for the plurality of the users and the conductor to perform the co-construction for the same concept and provide for the plurality of the users and the conductor to engage an instant messaging by enabling the instant messaging module in the concept map collaborative module, through the internet browser executed on the plurality of user devices and the conductor device; and the instant messaging module configured to provide for the plurality of the users and the conductor to engage an instant messaging and to enable the concept map collaborative module in response to an operation from the plurality of the users or the conductor, through the internet browser executed on the plurality of user devices and the conductor device.

Embodiment 4: The learning and creation system as described in Embodiment 1, the co-construction includes one of activates of a co-creation, a co-innovation, a mutual discussion, a brain storming, a collaborative working, a partnership working, and a combination thereof.

Embodiment 5: The learning and creation system as described in Embodiment 1, the plurality of user devices and the conductor device are a notebook computer, a desktop computer, a tablet device, or a smart phone.

Embodiment 6: The learning and creation system as described in Embodiment 1, the internet consists of a local area network, a wide area network, a GSM network, a 4G network, a 5G network, a 6G network, a Wi-Fi network, a Bluetooth network, and a combination thereof.

Embodiment 7: A computer program product, embodied on a non-transitory computer-readable storage medium and loaded and executed by a computerized system including a central server and a plurality of user devices being communicatively linked with each other through an internet, for learning and creation based on social network, includes: a computer code of a concept map collaborative module configured to provide for a plurality of users to operate through an internet browser executed on the plurality of user devices, provide a plurality of graphical objects based on the graphical concept map for the plurality of the users to perform a co-construction for the same concept through the internet browser in response to operations from the plurality of users, and provide for the plurality of the users to engage an instant messaging by enabling an instant messaging module in the concept map collaborative module; and a computer code of an instant messaging module configured to provide for the plurality of users to operate through the internet browser executed on the plurality of user devices, and provide for the plurality of the users to engage the instant messaging or enable the concept map collaborative module through the internet browser in response to operations form the plurality of users.

Embodiment 8: The computer program product as described in Embodiment 7, further includes: a computer code of a social network module configured to provide for the plurality of users to operate through the internet browser executed on a plurality of user devices, and provide for the plurality of users to build a social network through the internet browser executed on the plurality of user devices in response to operations form the plurality of users; a computer code of a co-construction process as the note module configured to provide for the plurality of users to operate through the internet browser executed on the plurality of user devices, and provide for the plurality of users to organize all of co-construction processes performed by the plurality of the users as a note automatically through the internet browser executed on the plurality of user devices in response to operations form the plurality of users; a computer code of an assignment management module configured to provide for the plurality of users to operate through the internet browser executed on the plurality of user devices, and provide for the plurality of the users to manage an assignment and to submit the assignment to a conductor through the internet browser executed on the plurality of user devices in response to operations form the plurality of users; and a computer code of a friend request module configured to provide for the plurality of users to operate through the internet browser executed on the plurality of user devices, and provide for the plurality of the users to newly add a friend through the internet browser executed on the plurality of user devices in response to operations form the plurality of users.

Embodiment 9: The computer program product as described in Embodiment 7, the co-construction includes one of activates of a co-creation, a co-innovation, a mutual discussion, a brain storming, a collaborative working, a partnership working, and a combination thereof.

Embodiment 10: The computer program product as described in Embodiment 7, the plurality of user devices and the conductor device are a notebook computer, a desktop computer, a tablet device, or a smart phone.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

1. A learning and creation system based on social network, comprising:
a central server installed with a social network based learning creation computer program product comprising a social learning network module, a concept map collaborative module and an instant messaging module to provide for a plurality of users to perform a co-construction activity for the same concept;
a plurality of user devices, each of which the plurality of user devices executes an internet browser, in communication with the central server through an internet, and accesses the social network based learning creation computer program product through the internet browser and provides the social learning network module, the concept map collaborative module and the instant messaging module for a user to operate in response to an operation from the user,
wherein the concept map collaborative module is configured to have a whiteboard providing with a plurality of diagrammatic objects representing different constituting components forming a concept map opened for the plurality of the users to manipulate to collaboratively sketch the concept map on the whiteboard so as to perform a co-construction for the same concept and embed the instant messaging module in the whiteboard for providing for the plurality of the users to engage an instant messaging to instantly exchange information and ideas in the concept map collaborative module, through the internet browser,
the social learning network module is configured to provide for the plurality of the users to post information and a piece of data or initiate an interactive discussion thereamong to build a social learning networking, and have a talk button and an idea initiation button or the plurality of the users to press to respectively enable and enter the instant messaging module to engage the instant messaging and the concept map collaborative module to initiate new concept, and
the instant messaging module is configured to provide for the plurality of the users to engage an instant messaging, and have a new idea button for the plurality of the users to press to enable and enter the concept map collaborative module to initiate new concept,
such that the social network based learning creation computer program product is configured to render the social learning network module, the concept map collaborative module and the instant messaging module crossly correlated to render the co-construction activity and the social learning networking reduced to practice.

2. The learning and creation system as claimed in claim 1, further comprising:
a guider device executing an internet browser, in communication with the central server through an internet, and accessing the social network based learning creation computer program product through the internet browser and providing the social learning network module, the concept map collaborative module and the instant messaging module for the guider to operate in response to an operation from the guider.

3. The learning and creation system as claimed in claim 2, wherein the social network based learning creation computer program product further comprises:
a co-construction process as the note module configured to provide for the plurality of the users and the guider to automatically organize all of co-construction processes performed by the plurality of the users and the guider as a note automatically through the internet browser executed on the plurality of user devices and the guider device;
an assignment management module configured to provide for the plurality of the users to manage an assignment and to submit the assignment to the guider through the internet browser executed on the plurality of user devices and the guider device; and
a friend request module configured to provide for the plurality of the users and the guider to newly add a friend through the internet browser executed on the plurality of user devices and the guider device.

4. The learning and creation system as claimed in claim 1, wherein the co-construction comprises one of activates of a co-creation, a co-innovation, a mutual discussion, a brain storming, a collaborative working, a partnership working, and a combination thereof.

5. The learning and creation system as claimed in claim 1, wherein the plurality of user devices and the guider device are a notebook computer, a desktop computer, a tablet device, or a smart phone.

6. The learning and creation system as claimed in claim 1, wherein the internet consists of a local area network, a wide area network, a GSM network, a 4G network, a 5G network, a 6G network, a Wi-Fi network, a Bluetooth network, and a combination thereof.

7. A computer program product, embodied on a non-transitory computer-readable storage medium and loaded and executed by a computerized system comprising a central server and a plurality of user devices being communicatively linked with each other through an internet, for learning and creation based on social network, comprising:
a computer code of a concept map collaborative module configured to provide for a plurality of users to operate through an internet browser executed on the plurality of user devices, have a whiteboard providing with a plurality of diagrammatic objects representing different constituting components forming a concept map opened for the plurality of the users to manipulate to collaboratively sketch the concept map on the whiteboard so as to perform a co-construction for the same concept and embed the instant messaging module in the whiteboard for providing for the plurality of the users to engage an instant messaging to instantly exchange information and ideas in the concept map collaborative module;
a computer code of a social learning network module is configured to provide for the plurality of the users to post information and a piece of data or initiate an interactive discussion thereamong to build a social learning networking, and have a talk button and an idea initiation button or the plurality of the users to press to respectively enable and enter the instant messaging module and the concept map collaborative module to initiate new concept; and
a computer code of an instant messaging module configured to provide for the plurality of users to operate through the internet browser executed on the plurality of user devices, and provide for the plurality of the users to engage the instant messaging and have a new idea button for the plurality of the users to press to enable and enter the concept map collaborative module to initiate new concept,
wherein the computer program product is the social network based learning creation computer program product which is configured to render the social learning network module, the concept map collaborative module and the instant messaging module crossly correlated to render the co-construction activity and the social learning networking reduced to practice.

8. The computer program product as claimed in claim 7, further comprising:
a computer code of a co-construction process as the note module configured to provide for the plurality of users to operate through the internet browser executed on the plurality of user devices, and provide for the plurality of users to organize all of co-construction processes performed by the plurality of the users as a note automatically through the internet browser executed on the plurality of user devices in response to operations form the plurality of users;
a computer code of an assignment management module configured to provide for the plurality of users to operate through the internet browser executed on the plurality of user devices, and provide for the plurality of the users to manage an assignment and to submit the assignment to a guider through the internet browser executed on the plurality of user devices in response to operations form the plurality of users; and
a computer code of a friend request module configured to provide for the plurality of users and the guider to operate through the internet browser executed on the plurality of user devices, and provide for the plurality of the users to newly add a friend through the internet browser executed on the plurality of user devices and the guider device in response to operations form the plurality of users.

9. The computer program product as claimed in claim 7, wherein the co-construction comprises one of activates of a co-creation, a co-innovation, a mutual discussion, a brain storming, a collaborative working, a partnership working, and a combination thereof.

10. The computer program product as claimed in claim 7, wherein the plurality of user devices and the guider device are a notebook computer, a desktop computer, a tablet device, or a smart phone.
